(19) United States
(12) Patent Application Publication
(10) Pub. No.: US 2002/0059587 A1
(43) Pub. Date: May 16, 2002

(54) Method and apparatus for providing personalized services

(75) Inventors: John C. Cofano, Redmond, WA (US); William E. Crounse, Bellevue, WA (US); Tim P. Gelinas, Sammamish, WA (US); Michelle Nitz-Weiss, Seattle, WA (US); Kenneth D. Graham, Bellvue, WA (US)

Correspondence Address: Brian J. McNamara, FOLEY & LARDNER, Washington Harbour, 3000 K Street, N.W., Suite 500, Washington, DC, 20007-5109, US

(73) Assignee: VIRTUAL CLINIC, INC.

(21) Appl. No.: 09/862,472

(22) Filed: May 23, 2001

Related U.S. Application Data
(60) Provisional application No. 60/206,551, filed on May 24, 2000.

(51) Int. Cl. H04N 7/025

(52) U.S. Cl. 725/35

(57) ABSTRACT

A computer network implemented method, system, and software provides personalized services using a digital dialog between a service provider and a user of the personalized services by establishing an audio/video communication channel for a service session between the user and the service provider, and receiving and storing inputs from the service provider and the user in a data store while the audio/video communication channel between the user and the service provider is established. The service provider and the user are provided interactive access to the data store while the audio/video communication channel is established between service provider and the user. Prior to establishing the service session using the audio/video communication channel, the service session is scheduled based on input from the user; and service session related information is received and stored from the user.

### CROSS REFERENCE TO RELATED APPLICATIONS

This application claims the benefit of priority under 35 U.S.C. 119(e) of provisional application 60/206,551 filed on May 24, 2000. The contents of this provisional application (including all appendices) is incorporated herein in its entirety.

### BACKGROUND OF THE INVENTION

The invention relates to automated systems for providing personal services. In particular the invention provides a method and apparatus that can be used by businesses and other organizations to allow their members or employees remote access to personalized services, for example, by providing a digital dialog mechanism offered through a computer server. This results in reducing or eliminating the need for members or employees to expend valuable time personally visiting service providers, such as doctors, travel agents, and financial advisors. The method and apparatus according to the invention also allows employers and organizations to provide their employees and members with value added services, such as buying services, without requiring the employees or members to make personal visits to the service providers and to conduct related performance monitoring and statistical research.

### Description of the Related Art

In attempts to manage benefit and service cost, many organizations have tried an array of alternative expense reducing solutions. For example, employers have attempted to reduce healthcare costs by relying on health maintenance organizations (HMOs), on-site healthcare, and wellness programs. One goal of such on-site healthcare and wellness programs is to reduce employees' time away from the workplace. On-site healthcare programs, however, are unattractive because they are extremely capital intensive and require organizations not in the healthcare field to divert resources to such programs. Similarly, wellness programs have the disadvantage that mobile employees in today's economy often benefit most from the wellness programs in the long-term rather than while they are employed by the employer subsidizing the wellness program. An increasing demand for qualified staff and the shortage of workers have helped to create a market economy in which workers expect enhanced benefit packages. One way to enhance benefits and to provide competitive salaries is to reduce the cost of the benefits by taking advantage of economies available through computer networks, such as the Internet. The invention herein provides a method and apparatus which can be used in a wide variety of ways to provide benefits to employees or members of other organizations.

Healthcare services is a typical benefits area. Consumers feel less in communication and more isolated from their doctors than ever. Millions of such consumers now use the Internet to search for health and medical information. Some healthcare organizations have attempted to use the Internet as a way for on-line consumers to communicate with doctors through electronic mail, find out test results and make appointments. Such a system, however, provides little advantage over traditional telephone conferencing because it is simply another way of packaging services already available.

Some physicians have worked with patients in the video conference format using traditional telemedicine techniques. However, the use of dedicated cameras and televisions for telemedicine is expensive and has resulted in limiting such techniques to exclusively targeted markets, such as remote and rural areas where there is no reasonable alternative to providing healthcare.

Recently a number of web sites such as drkoop.com™ have appeared providing on-line access to healthcare information. Such web sites often raise revenue through advertising. Other web based approaches include America's Doctors Online and Cyberdocs.com™, which offer consultation in the form of an on-line chat room. Cyberdocs.com™ recently began offering live on-line videoconferencing over the Internet, with the ability to prescribe medication for patients in the same state as the doctors on their staff. Cyberdocs.com™ charges the patient for these on-line videoconferences.

None of the currently available approaches discussed above provides a system wherein, on short notice, an employee or other group member can logon to a service provider, such as a medical professional, arrange an on-line appointment, remotely receive services such as medical diagnostic services, automatically co-relate the service received with patient or treatment data in digital or computer readable form, and determine if a follow-up in-person appointment or service is required.

### SUMMARY OF THE INVENTION

The invention disclosed herein seeks to eliminate the above discussed deficiencies in the related art. Therefore, one general object of the present invention is to alleviate the above discussed problems and deficiencies. A method and apparatus according to one aspect of the present invention employs computers which communicate over a network, such as the Internet, to allow a member of an organization, such as an employee in a company, to obtain benefits at several levels through computer communications. Thus, it is an object of the invention to provide a system wherein a user at a remote computer can obtain information about services offered by a service provider, or can communicate with the service provider to obtain on-line service.

It is a further object of the invention to provide a system wherein the user and service provider can determine if additional service, such as an in-person appointment, is appropriate and can facilitate scheduling delivery of such services.

It is a still further object of the invention to provide a method and apparatus which allows a service provider to deliver services to a user in a secure and private environment.

It is a still further object of the invention to provide a method and apparatus by which benefits administrators can access raw data for use in developing statistics about the benefit services.

It is a still further object of the invention to provide a method and apparatus by which benefits administrators can communicate to users of the system and service providers.

It is a still further object of the invention to provide data mining capabilities that can be accessed by research services.

It is a still further object of the invention to provide a method and apparatus for service providers to obtain data, such as feedback data related to the performance of their services.

The above and other objects of the invention are accomplished by an apparatus implementing a method which allows a remote user, such as an employee, to communicate with a service provider, such as a healthcare provider. In one implementation, the employee and the service provider can communicate via e-mail and videoconferencing through the Internet. A secured intranet server is also provided. The intranet server provides transaction assistance to the service provider and forwards provider recommendations to the employee. The employee can forward feedback, such as service provider performance and quality information, to the intranet server where such data can be stored. In accordance with the invention, the server can store and track data to allow organizations to quantify benefits issues and problems, do outcomes research, monitor benefit service quality information, insert reminders onto employers' calendars, develop rules for service delivery, update directories and provide targeted service information. According to the invention, authorized service providers and information content providers can access the intranet server to place content on the system and to receive feedback information on performance and quality of service. The secure server also allows benefits managers to use the system to collect data for billing purposes and for analyzing the benefits concerns of the workforce. Moreover, the system according to the invention allows researchers to access the database developed on the intranet server in order to perform complex studies of the user population. Such studies could be performed for the benefits administrators or could be independent studies. Benefits administrators could charge for access to the data for independent studies, thereby creating a revenue stream that helps fund such a benefits system.

In one aspect, the present invention provides a computer implemented method of providing personal services over a computer network, the method including: receiving a service request from a user; determining a user type; providing a menu of service request options corresponding to the determined user type; receiving a selected service request option from the user; determining a service response based on information related to the user; providing services in accordance with the selected service request option and the determined service response; and recording interactions while providing the selected service request option.

In one aspect of the present invention, the personal services comprises healthcare related services.

In another aspect of the present invention, the user type comprises one of a member/employee, a service provider, an administrator, a research service, and a service partner.

In one aspect of the present invention, the step of recording interactions includes storing information regarding type of service provided, user requesting service, service provider information and recommendations, frequency of service provided by user and/or service provider, outcome information, feedback from user, and performance metrics.

Another aspect of the present invention further includes: calculating outcome data; and providing non-confidential outcome data to a research service.

Another aspect of the present invention further includes: calculating service usage by user, service type, and outcomes; and providing calculated service usage to an administrator.

A further aspect of the present invention includes: calculating performance metrics by respective service providers; and provide respective performance metrics to the respective service providers.

In one aspect of the present invention, the service response is determined based on information related to the medical history of the user.

In another aspect of the present invention, the service response is determined based on information related to a work schedule of the user.

In another important aspect the present invention provides a computer readable data storage medium having program code recorded thereon for providing personal services over a computer network, the program code including: a first program code that receives a service request from a user and determines user type; a second program that provides a menu of service request options based on determined user type; a third program code that receives a selected service request option from the user; a fourth program code that determines a service response based on information related to the user; a fifth program code that provides services in accordance with the selected service request option and the determined service response; and a sixth program code that records interactions while providing the selected service request options.

In another important aspect, the present invention provides a system for providing personal services over a computer network, the system including: a user interface unit for receiving a service request from a user and determining a user type; a server unit that provides a menu of service request options based on the user type and receives a user selected service request option through the user interface unit, the server unit determining a service response based on information related to the user and providing services in accordance with the selected service request option and the determined service response; and a data storage unit that records all interactions while providing the selected service request option.

In another important aspect of the invention, the present invention provides a computer implemented method of providing personalized services using a digital dialog between a service provider and a user of the personalized services, the method including: establishing an audio/video communication channel for a service session between the user and the service provider; receiving and storing inputs from the service provider in a data store while the audio/video communication channel between the user and the service provider is established; receiving and storing inputs from the user in the data store while the audio/video communication channel between the user and the service provider is established; and providing, the service provider and the user, interactive access to the data store while the audio/video communication channel is established between service provider and the user.

In one aspect, the present invention further includes: prior to establishing the service session using the audio/video communication channel, scheduling the service session based on input from the user; and receiving service session related information from the user; and storing received service session related information in the data store.

In a further aspect, the present invention provides that the service provider can access user inputs stored on the data store, and that the user can access selected service provider inputs stored on the data store.

In another aspect, the present invention includes: associating, with the service session, interactive prompts to the service provider; receiving and storing service provider responses to the prompts provided to the service provider; and providing additional prompts to the service provider based on the received responses from the service provider.

In another aspect, the present invention further provides: providing interactive prompts to the user; receiving and storing user responses to the prompts provided to the user; and providing additional prompts to the service provider based on the received responses from the service provider.

In one aspect, the present invention further includes: providing, from the service provider, interactive prompts to the user; receiving, from the user, responses to the interactive prompts provided by the service provider; and providing to the service provider the received responses from the user.

A further aspect of the present invention further includes storing the prompts and received responses as a permanent data record for the service session. The prompts and received responses may be stored and classified in the permanent data record based on keywords associated with the prompts and received responses. The prompts may include labeled or unlabeled data entry fields, diagrams, prior session data, or service session related information provided by the user prior to the service session.

In one aspect of the present invention, the audio/video communication channel includes videoconferencing. The audio/video communication channel may be a communication channel over a private communication network or a public communication network such as the Internet.

In one aspect of the present invention, the audio/video communication channel includes a browser based access to the public or private communication channel.

In one aspect, the present invention includes: providing the service provider with a multi-window interface to the communication channel, wherein one or more windows provide access to audio/video data transmitted across the communication channel, and wherein one or more windows synchronously provide access to the data store storing inputs from the service provider and the user and any earlier service session related information provided by the user; and one or more windows synchronously provide access to one or more information sources useful to the service provider.

In one aspect, the present invention further includes: providing the user with a multi-window interface to the communication channel, wherein one or more windows provide access to the audio/video data transmitted across the communication channel, and wherein one or more windows synchronously provide access to additional information useful to the user.

In one aspect of the present invention, the step of establishing an audio/video communication channel further includes: placing a received user connection in a “waiting room” queue for a particular service provider; and monitoring the queue to connect the user to the service provider by using a priority protocol to schedule the users in the queue. It may also include providing a user with an indication of their position in the queue.

In a further aspect, the present invention includes generating asynchronous messages to the user or the service provider based on data stored in the permanent data record.

In one important aspect, the present invention includes a computer readable data storage medium having program code recorded thereon for providing personalized services using a digital dialog over a computer network between a service provider and a user of the personalized services, the program code including: a first program code for establishing an audio/video communication channel for a service session between the user and the service provider; a second program code that receives and stores inputs from the service provider in a data store while the audio/video communication channel between the user and the service provider is established; a third program code for receiving and storing inputs from the user in the data store while the audio/video communication channel between the user and the service provider is established; and a fourth program code that provides the service provider and the user interactive access to the data store while the audio/video communication channel is established between the service provider and the user.

In another important aspect, the present invention provides as system for providing personalized services using a digital dialog over a computer network between a service provider and a user of the personalized services, the system including: a service provider interface that communicates with a user interface using an audio/video communication channel in a service session; and a server unit that communicates with both the service provider interface and the user interface while the service provider interface communicates with the user interface using the audio/video communication channel in the service session; wherein the server unit comprises a data store that is interactively accessible by the service provider interface and the user interface during the service session.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a block diagram illustrating the system components of a preferred embodiment of the present invention.

FIG. 2 is flow diagram illustrating the use of the system by entities accessing the system.

FIG. 3 is a flow diagram illustrating the steps when the system is accessed by a group member or a employee.

FIG. 4 is a diagram illustrating items that may appear on a service provider menu.

FIG. 5 is a block diagram of the components used in a “digital dialog” feature of the present invention.

FIG. 6 is an illustration of exemplary patient interface display.

FIGS. 7A-7D are illustrations of various stages visible in a doctor interface while a patient has connected for a service session.

FIG. 8 is an illustration of the patient interface display after the doctor has initiated a videoconference service session with the patient.

FIGS. 9A-9B illustrate the doctor interface display while the service session is in progress.

FIG. 10 is an illustration of the patient interface display while the service session is in progress.

FIGS. 11A-C are illustrations showing treatment related instructions for the patient based on the service session.

FIG. 12 is an illustration showing the prescription for treatment of the patient based on the service session.

### DETAILED DESCRIPTION OF THE PREFERRED EMBODIMENTS

A method and apparatus according to the invention can be used to provide services to members of a group accessing the system through remote computers. The members of the group could be employees or members of another organization. Service providers can provide services in any number of fields, such as investment services, travel services, buying services, and healthcare services. The invention is not restricted by the group membership or by the type of services provided. For convenience, however, the method and apparatus according to the invention will be described herein in the context of employees accessing healthcare services. Those of ordinary skill will recognize that the context of employees accessing healthcare services is by way of illustration and not limitation.

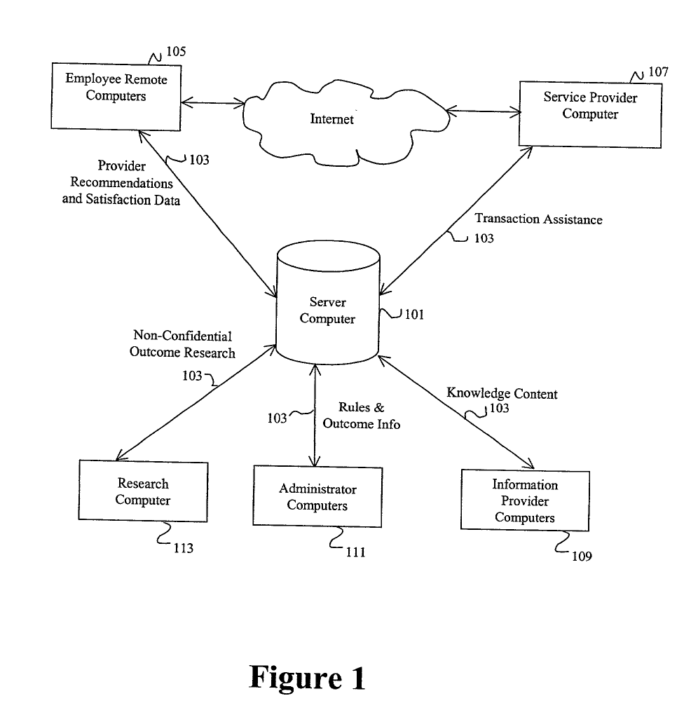

FIG. 1 illustrates the elements of the system according to the invention. As shown in FIG. 1, computers such as remote computers used by employees, service provider computers, researcher computers, administrative computers and information provider computers communicate with a server computer. Those of ordinary skill will recognize the elements of each computer include a processor, memory, storage devices, and communications equipment. The memory of each computer can include operational programs (an operating system, BIOS, etc.) for operating the individual computer and other programs for performing tasks such as communicating with other computers. The processor in each computer executes the stored programs. Individual computers also have memories and storage devices which store data and other information, as is known to those of ordinary skill in the art. Furthermore, one of skill in the art would also recognize that while the server computer 101 is depicted as one block, it could also be implemented as a networked computer system with local and remote data storage as long as the networked components were configured to operate in accordance with the server computer functionality disclosed herein.

As shown in FIG. 1, server computer 101 links to the computers of the other system elements through communication links 103. One way of implementing such a system is through an intranet. The system can be implemented using any known intranet technology or other network technology which can provide links from the individual computers to the server computer. The communication links can be implemented as a secure or non-secure system in accordance with the invention. In most instance, employers will prefer to use a secure system, so that information personal and private to individual users is not distributed beyond those authorized to receive it.

FIG. 1 also illustrates computers 105 located at the sites of the typical users. Employees access the system through remote computers shown at 105. In the context of a healthcare system, an employee patient would enter the system through his remote computer, such as a desktop or portable laptop computer. In this mode, the computer could function as a personal healthcare portal (PHP) which provides access, preferably secure access, to an e-mail and videoconferencing system with healthcare providers. An employee could also access a search engine in the server computer (or server unit) 101 in order to obtain healthcare news and other information regarding health and medicine. The information is provided as knowledge content from an information provider through the information provider's computers 109.

The server (or server unit) 101 may operate by providing links, such as hyper text markup language (HTML) links to information stored at the information provider's computers. Thus, the server computer 101 can contain databases of information and databases of links to sources of additional information (collectively a data storage unit). Of course, the information providers using computer 109 could link a user at remote computer 105 to other content providers through the internet or other computer or communications network. Furthermore, the server unit 101 is associated with a user interface unit that communicates with the various users of the system that access the server unit 101 from, for example, the employee remote computers 105, the service provider computers 107, the information provider computers 109, the administrator computers 111, and the researcher computers 113.

The search engine implemented in the server computer can employ any search strategy appropriate to the request for information from the employee remote computer 105. As previously noted, the example given herein concerns providing healthcare benefits. However, those of ordinary skill will recognize that according to the invention, the subject matter of the service inquiry need not be limited to healthcare. For example, the employee could use his remote computer 105 to access financial service information from a financial information provider computer 109. Similarly, the service provider using computer 107 need not be a medical service provider, but could be a financial services provider, within the scope of the invention.

Returning to the discussion of the invention in the context of a healthcare benefit provider, a physician service provider using a computer 107 can access e-mail and videoconferencing resources to communicate with employee users at computers 105. Server computer 101 selects particularized healthcare information to provide the employee at remote computer 105 and the healthcare professional at computer 107, based on the context of the correspondence between the employee and the healthcare provider. For example, a specific set of symptoms described by an employee may trigger the server computer 101 to route information to the employee about potential conditions. The source of this information might be information provider computers 109. The server computer 101 can also route to the service provider computer 107 additional information which the healthcare service provider may use to assist in diagnosing the employee. The healthcare provider is, of course, free to ignore information he receives from the server computer 101 and to rely on his own best judgment.

Administrators, such as corporate benefit managers using administrator computers 111 may find it useful to access the server 101 to determine statistical information about the health patterns of employees. In this case, however, privacy concerns of employees may be paramount. Therefore, an optional software filter in the server computer 101 may ensure that the administrators have access only to statistical data or aggregate data stripped of personal identification information, and therefore, not to data that can be associated with individuals. Statistical data may be useful in determining certain patterns of health problems that can lead to additional services. For example, a determination that a significant number of employees experienced a particular type of cold or flu might lead to the suggestion that the following year employees have the option to receive free or low cost flu shots at the employer's facility.

Researchers using research computers 113 can also do sophisticated searches of the database to accomplish complex studies based on the user population. As is the case with benefit managers or administrators using computers 111, researchers using computers 113 would, preferably, obtain data devoid of patient identifiers.

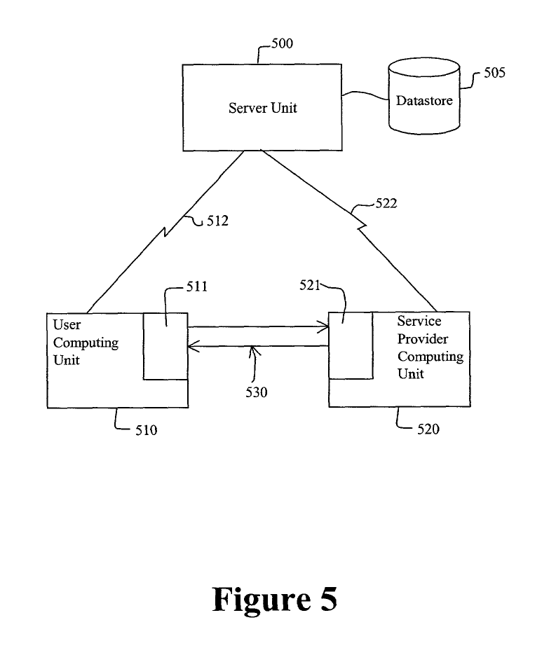

Another feature according to the invention is the ability of the employee to receive medical services through a “virtual office visit” rather than by leaving the employer's facility for an in-office physician visit. Further details of conducting such a virtual office visit is discussed further herein with reference to FIG. 5 onwards which discuss a “digital dialog” feature of the present invention that can be used to conduct the virtual office visit and integrate and store data associated with the virtual office visit. In the case of a minor illness or injury, the employee would visit the healthcare provider using the on-line videoconferencing features discussed herein, schedule appointments with doctors and purchase prescriptions and other healthcare supplies on-line. The purchased items are then delivered to an employee specified destination, such as the employee's home, office or hotel.

Server computer 101 acts as the heart of the network by managing information storage of corporate, employee and physician data and sending relevant data to each participant. Server computer 101 also processes the billing for services and sends it to the client corporation for payment. Server 101 also ensures the security of information stored for all participants. Using database techniques, the central server 101 records and tracks transaction-related information and provides automated functions that do not compromise employee confidentiality. Such features include physician quality data, patient satisfaction and physician profiles. A system according to the invention optionally uses the server computer 101 to collect medical and patient profile/health history data and help employers quantify health issues and identify health problems within the employee population. Outcomes research is also possible. Using the data stored on the server 101, benchmark data can be provided to employers to allow them to evaluate clusters of health related problems that might be improved by changes in the workplace. The server computer 101 according to the invention can also be used to monitor physician practice pattern variations using medical chart data.

As shown in FIG. 1, administrator computers 111 access server 101 to develop rules and outcome information. An example of a rule-based delivery system is one in which all participants in a category, such as women over forty, who do not have a particular procedure, such as a mammogram, listed on their charts, automatically receive e-mail from their physician recommending such a procedure. The system according to the invention can then provide a link to schedule an appointment for such a procedure. The results of the test are automatically routed to the doctor, who assesses the test and notifies the employee patient about the result. The server computer 101 also provides the capability of tracking drug compatibility and compliance by patients and inserting reminders into the patients' calendars for prescription renewals and medical tests. Lab and test results can be made available on-line to the doctor and the employee. Server 101 also updates provider directories and health benefit directories. Another feature available with server computer 101 is “push technology” in which employees who fill out a profile questionnaire can receive information targeted directly in response to their preferences and needs.

As previously noted herein, while the example herein is in the context of a healthcare delivery system, employees or other members of an organization can receive the same advantages for services such as financial planning, on-line purchasing and other activities.

The system according to the invention is most easily implemented with a plurality of particular software implemented interfaces designed to accommodate each of the system users. For example, an employee interface in a healthcare benefit system would include the patient's personal healthcare portal, as discussed previously herein. At initial logon the employee would fill out a detailed questionnaire concerning physician preferences, activities and requests for information. The profile of course could always be updated.

Service providers would have a service provider software package which provides an interface to link them to the server computer 101. Such an interface, preferably a web enabled application, would provide access to news and studies as well as an extensive database of knowledge. In the case of the healthcare provider the knowledge would be medical knowledge. The software package also allows the healthcare provider to access e-mail and videoconferencing resources. In the context of transaction assistance through communication link 103, a physician's office could also obtain billing records which could be downloaded on an episodic or periodic basis. This interface also provides assistance with other chores such as scheduling.

The information provider computers 109 have an interface program in which the providers access information about the perceived quality and validity of their service. In addition, the interface allows the information provider computers 109 to update information in the database of server computer 101.

Administrator computers 111 have a different interface which allows access to queries of information regarding billings and other conditions and concerns, such as those which pertain to an employer's workforce. Nearly any combination of data that does not violate the privacy of the system's users could be summoned and sorted to desired specifications. Reports can be generated on an episodic or periodic basis. Human resources professionals can distribute system-wide messages to employees and others through secure e-mail. “Virtual assistants” can also provide aid in using the system's messaging and other tools.

Because the server 101 contains a significant information base, it can be used on a pay-as-you-go or subscription basis by researcher computers 113 to access more data and evaluate it for trends and patterns. A researcher can customize a comprehensive search of the database and receive videoconference assistance from a data mining specialist working through an administrator computer 111. Research services can be narrow view or cross-industry. Of course, filters are employed to maintain patient and employer confidentiality so that competing users could not gain specific benefit from the information.

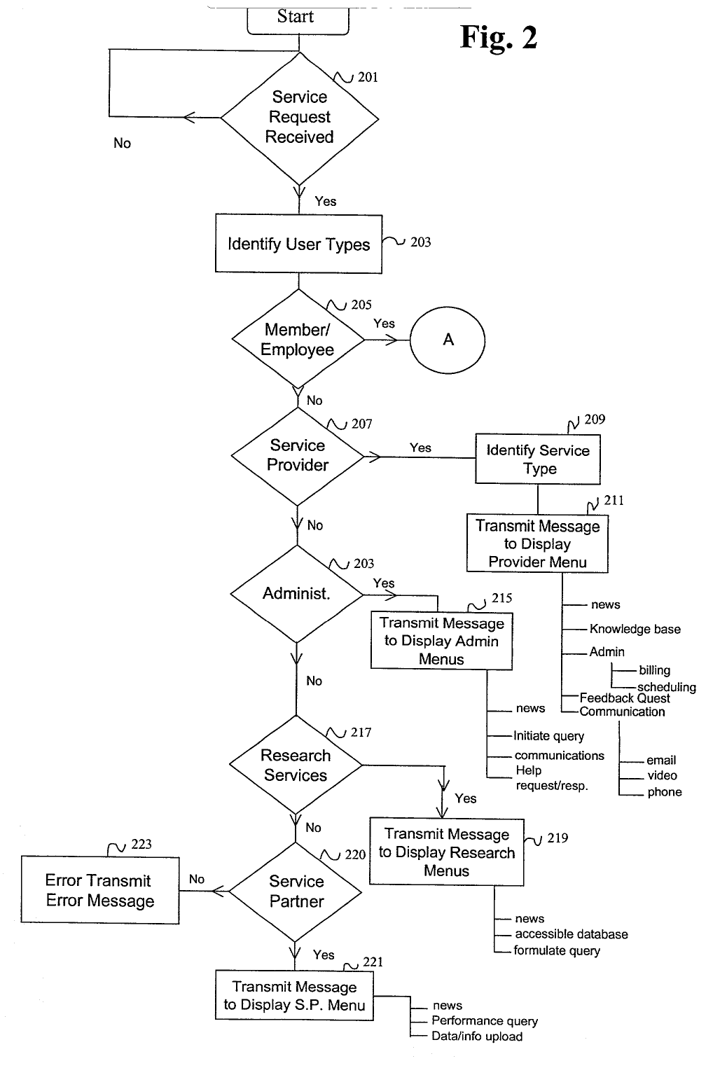

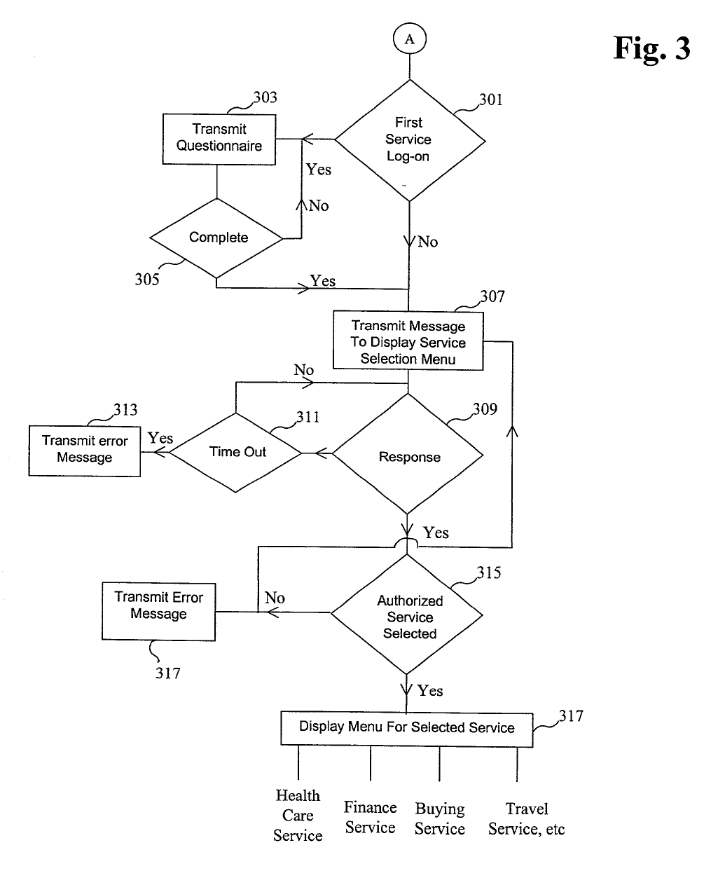

FIG. 2 is a flow diagram that illustrates how a system according to the invention can be used by the entities accessing the system to provide any number of services. In accordance with the method of the invention, at step 201 the server computer 101 determines whether a service request has been received. Once a service request has been received, server computer 101 identifies the user type so that the appropriate interface information is provided. This occurs at step 203. At step 205, if the user is determined to be a member of a group or an employee, the subsequent steps are discussed in detail in FIG. 3 as indicated by the label A that connects the steps in FIG. 3 to the flow diagram illustrated in FIG. 2. However, if in step 205, the user is determined not to be a member of the group or an employee, the server computer 101 then determines if the user is a service provider as shown at step 207. If so, at step 209 the server computer identifies the type of service provider accessing the system.

According to the invention, any type of benefit service provider can be included in the system, although the precise interface for each type of benefit service provider is somewhat different. Based on the identity of the service type determined in step 209, at step 211 the server computer 101 transmits a message to the service provider computer 107 to display the appropriate menu. As shown in FIG. 2, the exemplary menu could include such things as news relevant to the service provider, knowledge bases accessible to the service provider, administration information accessible to the service provider such as billing and scheduling information, feedback queries from the service provider and access to system communication resources such as e-mail, videoconferencing and telephone conferencing. Processing at the server computer then continues depending on the response received over communication link 103 from the service provider computer 107. For example, if a financial service provider selects “news” the server computer 101 would transmit both system specific administrative news and breaking news in the financial services industry. Similarly, where the benefits service provider is a medical service provider, the news could include system administration information and breaking news in the medical field. Those of ordinary skill will recognize that the particularized news and knowledge base access for each service provider can be arranged at multiple levels of specificity. Thus, as one example, a medical services provider could access a knowledge base concerning heart and pulmonary diseases or a second knowledge base concerning nervous system disorders. Thus, the news and the knowledge bases available to each service provider through the server computer 101 is a function of the specific needs of the service provider.

All service providers may require administrative information concerning billing, or scheduling, for example appointment scheduling. The system according to the invention also provides all service providers with the ability to query feedback statistics on their performance. This feature gives service providers information needed to upgrade their performance in areas users identify as deficient. All service provider computers receive access to the communication system. For example, when a user at a remote computer 105 sends an e-mail inquiry to the service provider, the service provider can respond by e-mail. The e-mail itself may be a complete response or may suggest that the service provider and the user arrange an appointment later in the day, for example a videoconference at a specific time. As discussed further herein, users may wish to access the service provider immediately, in which case the communication software allows the service provider to put the user's inquiry in a waiting queue and respond as service provider resources become available.

If the service inquiry is not from a service provider, as determined at step 207, then server 101 has to determine if the inquiry is from a benefits administrator at step 213. If so, at step 215 server 101 transmits a message to the administrator computer 111 to display the administrative menu. FIG. 2 shows, by way of example and not limitation, types of items which might appear on the administrative menu. For example, news related to system administrators, a selection to initiate a query of the system database, a communications selection so that the system administrators can transmit and receive e-mail and other messages, and a help request/response selection whereby the administrators can either respond to help requests from others or initiate help requests of their own. Those of ordinary skill will recognize that different organizations will require different administrative functions and that the functions shown here are by way of example and not limitation.

If the server computer 101 determines at step 213 that the request is not from a system benefit administrator, it may at step 217 determine if the request for service comes from a research service. If so, at step 219 server computer 101 transmits a message to display the research menus. FIG. 2 illustrates some examples of research menus to include news, a list of accessible databases and a “formulate query” selection. Those of ordinary skill will recognize that other options may also be possible as appropriate to research services and that such options may be accessible at multiples levels of specificity. For example, a query could access all databases, or only a limited number of databases depending on how the query is formulated and how the system is configured. Queries may also be formulated in any format compatible with search engines known in the art. Thus, the search strategy may employ boolean operators, natural language based or other search engine strategies.

If the request is not from a research service as determined at step 217, then at step 220 the system determines if the request comes from a service partner or information provider computer 109. If so, at step 221 server computer 101 transmits a message to display the service partner or information provider menu. FIG. 2 illustrates a sample menu to include news, or a performance query used by the information provider to determine how well its information is serving the needs of the user community. A response to such a query from the server computer would include suitability and assessment information which the information provider can evaluate. Another option is for the information provider to upload knowledge content to the server 101 in the form of data or other information. If at step 220 the server computer determines that no user type corresponds to the service request received, an error message is transmitted to the computer generating the request as shown at step 223.

FIG. 3 provides a more detailed view of steps which occur when the server computer 101 determines at step 205 that a member/employee is accessing the system for service. If at step 301 server computer 101 determines that this is the first service logon by the particular employee, then at step 303 the server computer transmits to the employee's remote computer 105 a questionnaire used to establish an underlying profile. The employee may select passwords or other access control information at this time. If at step 305, the server computer determines that the questionnaire is complete, control then transfers to step 307. If the questionnaire is not complete in step 305, control may optionally be passed back to step 303 to represent the questionnaire to the employee, for example, to fill out the incomplete data fields. At step 307 server computer 101 transmits a message to the remote computer to display a service selection menu. Step 307 would of course be bypassed in the circumstance where the employee is not eligible to select from a plurality of services. Assuming that there are multiple services for the employee to select, at step 309 server computer 101 determines whether or not it has received a response. If a response has not been received, at step 311 server computer determines whether a time-out has occurred. If an excessive amount of time has elapsed the system transmits an error message at step 313. Otherwise server computer 101 continues to await a response. When a response is received by server computer 101, control transfers to step 315. At step 315, server computer 101 determines if the service selected is authorized for the particular employee. If not, at step 317 the system transmits an error message to the employee's remote computer 105 and, optionally, returns to step 307 to present the employee with the service selection menu and await another selection by the employee. If the service selected is authorized for the employee or other user, then at step 317 the server computer transmits a message to display the menu for the selected service. Figure 3 illustrates, by way of example and not limitation a healthcare service, a finance service, a buying service, and a travel service. Those of ordinary skill will recognize that the system according to the invention could provide other services as well.

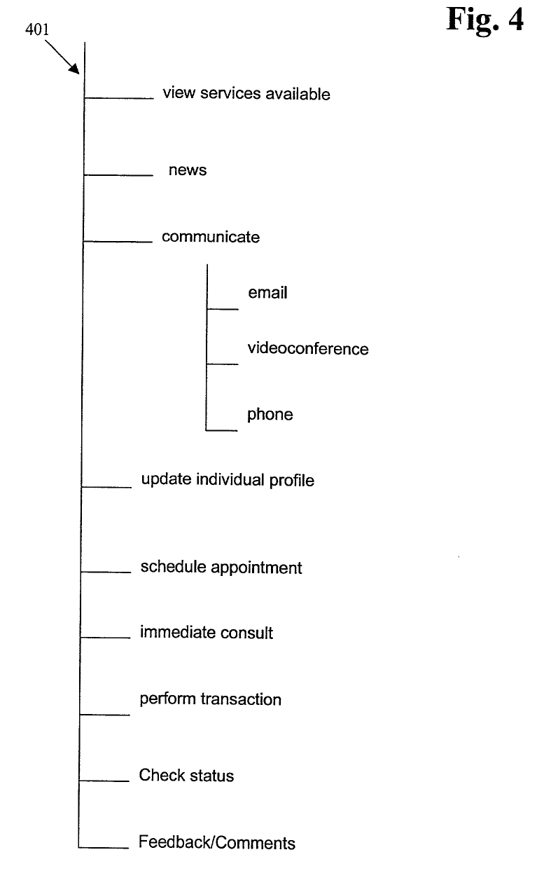

FIG. 4 illustrates some of the items which might appear on a typical service provider menu 401. These include a selection to view the services available, a news selection, a communication selection, and selections to update an individual profile, schedule an appointment, obtain an immediate consultation, perform a transaction, check the status of a transaction, and provide feedback and comments. The specific services available will depend on the service provider options. In many cases, a particular selection leads to a selection from a more detailed menu specific to the service provider. For example, a financial service provider might provide the options of obtaining mortgage banking information, investment information, stock prices, and other financial planning data. Similarly, a healthcare provider might provide options related to obtaining information about particular diseases, contacting a particular physician, or information on fitness, wellness and other health issues. A user might wish to update his individual profile for the service provider. For example, the questionnaire discussed in FIG. 3 provides a user profile for the server computer. However, the service provider using computer 107 may offer additional services based on an individual user's profile. An individual providing information concerning height and weight may wish to update the weight information as he progresses along a weight loss program.

One important application of the method and apparatus according to the invention is the availability of the “virtual office visit”. As discussed herein, the example is given in the context of healthcare. Those of ordinary skill will recognize that the “virtual office” visit feature can be implemented in any service provider's context, including financial planning services, investment services, travel services and other services. In one example, a typical user, Steve, wakes up feeling feverish and has developed a deep cough that produces a small amount of colored mucous. Steve is in the middle of an extensive project at work under a tight deadline, so he elects to go to his office. Given his time constraints, Steve is concerned about wasting a lot of time going to a doctor's office for something that may or may not need treatment. He seeks assistance and logs on to the system with his identification number and password. In this case, the server determines at step 205 that Steve is an employee and at step 301 that this is not his first logon. Steve selects the healthcare service at step 31 7. Steve considers obtaining an immediate consultation as shown in FIG. 4. Such a consultation can be implemented through an on-line videoconference with a doctor on call. Instead, Steve elects the communicate option and sends an e-mail to his own doctor for advice. In the e-mail Steve provides a brief description of his symptoms. Steve has the option of marking it important, urgent or not important. Steve elects to mark it as important rather than urgent, since he requires a response the same day, but he does not believe the condition requires urgent attention.

Steve's doctor uses a service provider computer 107 to check his e-mail and reads Steve's message. From Steve's symptom description, it sounds like Steve may have bronchitis. The doctor checks his appointment book and realizes he is scheduled to be on-call for drop in appointments that afternoon via videoconference. He e-mails Steve asking if he would like to reserve some of his time for an on-line videoconference that afternoon to help him determine his problem. Steve receives a confidential e-mail and sets up an appointment with the doctor on-line that afternoon. When Steve logs on again he is prompted with the message confirming his appointment and is asked to fill out a brief questionnaire to make his visit with the doctor more complete and efficient. The basics of Steve's medical history are in the database on server 101, so he confirms the information as accurate and provides information about why he is seeking the doctor's assistance today. The doctor using a service provider computer 107 has access through server computer 101 to Steve's medical records and reviews them before conducting the on-line videoconference. He notices that Steve has no history of asthma or other chronic pulmonary problems, but does have borderline high blood pressure. Recognizing this, the doctor determines it may affect the type of medication he can prescribe.

As Steve logs on, he receives a message that the doctor will be with him shortly and is asked if he wants to follow some links to a database related to the concerns he raised in his questionnaire. Steve elects to follow some links in this “virtual waiting room.” Server computer 101 sent the complete responses to the questionnaire to Steve's. The information was then also filtered at server 101 through a screen that removes personal information about Steve. The server computer then adds the information to a pool of information about health issues of the corporation's employees in general.

When the doctor is available, server 101 interrupts Steve's access to links in the virtual waiting room and connects the videoconference. As the videoconference begins, the doctor becomes convinced that like many patients that day, Steve's cold has developed into a secondary bronchitis. Reviewing the medical history and talking with Steve, the doctor is confident that Steve will benefit from a short course of an antibiotic and mild cough suppressant/expectorant combination. He reviews Steve's record and finds no contradiction for prescribing Erythromycin. Steve instructs the doctor to send the prescription directly to the on-line pharmacy which will then deliver the prescription to Steve's office by the end of the day. Steve also asks about high blood pressure and the doctor advises him concerning periodic checks of his blood pressure numbers.

Using service provider computer 107, the doctor then clicks on a specific menu prescription button to send a prescription to the on-line pharmacy. The server computer 101 automatically checks the patient's profile for possible drug interactions with other medications the patient may take. The doctor receives a message confirming there are no harmful interactions. The doctor also asks the system to remind him in three days to check on Steve's progress. Thus, Steve has conferred with the doctor and received treatment through a “virtual office visit” that did not require Steve to take the time to leave his office or fill his own prescription.

At the end of the conference, Steve receives an inquiry concerning the appointment he just had with his doctor. Steve fills out an inquiry form, which is transmitted to the database as part of the assessment process for the service provider. Steve also receives from server 101 on-line information detailing the results of his consultation, including patient instructions, precautions, follow-up information and information about his medications. Steve also receives an e-mail from the server about the database, offering links to additional on-line information on bronchitis, the common cold, high blood pressure and stress management. Shortly thereafter Steve receives an e-mail from his pharmacy confirming that prescriptions were received from his doctor and asking if they should be sent home or to his office. Steve elects to have them sent to the office. Three days later the doctor logs on and receives an e-mail from server computer 101 reminding him to check on Steve's progress. The doctor then sends an e-mail to Steve who responds that the cough is nearly gone and his temperature is back to normal. The doctor reminds Steve to finish all the antibiotics prescribed even though the symptoms are disappearing.

Sometime later, a human resources representative with Steve's company using an administrative computer 111 queries the database and obtains a list of common health concerns of employees over the last month. The chart shows a number of people concerned about coughs, colds, high blood pressure, and allergies. The human resources representative graphs the information and takes it to his supervisor. Since a significant number of employees are concerned about blood pressure, they suggest an automated blood pressure machine in each of the company's buildings enabling employees to watch their own health. The administrators also ask the facilities department to check filters on the climate control system to see if they need replacement or upgrading to help employees who are suffering from allergies.

Later that year a magazine reporter doing an article on blood pressure uses a research computer 113 to access information about patterns of blood pressure problems in the workplace. The employer's organization receives payment for the researcher's access to the system.

FIG. 5 is a block diagram of the components used in a “digital dialog” feature of present invention which provides an audio/video service session interaction between a service provider and a user and integrates and stores data associated with the service session in a data store 505 associated with a server unit 500. Furthermore, the data associated with the service session can include data provided earlier by either the user (at a user computing unit 510) or the service provider (using a service provider computing unit 520). In addition, data generated during the service session can also be stored. Furthermore, the data associated with the service session can be classified based on keywords or other intelligence programmed in the server unit 500 or other indications provided by either the user or the service provider. Therefore, all the data related to the service session can be stored in the data store 505 as a permanent record to provide a historical data record across multiple service sessions for a particular user.

It should be recognized that the server unit 500 discussed herein could be the server computer 101 disclosed in FIG. 1, while the service provider computing unit 520 could be the service provider computer 107 in the FIG. 1. Likewise, the user computing unit 510 could be the employee remote computer 105 in FIG. 1.

Returning to the digital dialog components disclosed in FIG. 5, user computing unit 510 includes a user interface 511 which is capable of providing an audio/visual communication with a service provider interface 521 provided in the service provider computing unit 520 over an audio/video communication channel 530. An example of such a audio/video communication is a videoconference. Furthermore, one skilled in the art would recognize that while the audio/video communication channel 530 is shown as a direct link between the user computing unit 510 and the service provider computing unit 520, it could include intermediate videoconferencing servers or the like. Furthermore, such a videoconferencing server could also be provided on the server unit 500.

The user interface 511 is preferably a multi-window interface in which one window (or more) provides access to the audio/video communication channel for providing a user with an audio/video service session interaction with the service provider. The user interface 511 also communicates with the server unit 500 (and the data store 505 associated therewith) through a data communication link 512 so that the server unit 500 can generate prompts to the user interface 511 and receive and store responses from the user interface 511. The user interface 511 can also initiate communication with the server unit 500 using the data communication link 512 to access services provided by the server unit 500, for example, to schedule a service session, to pose questions to the service provider, to provide service session related information in advance of a scheduled service session, to retrieve service provider instructions after a service session interaction, or access informational content accessible through the server unit 500. The multi-window user interface 511 can provide additional windows so that several of these interactions can occur simultaneously through respective windows.

Likewise, the service provider interface 521 is also preferably a multi-window interface in which one window (or more) provides access to the audio/video communication channel for providing a user with an audio/video service session interaction with the service provider. The service provider interface 521 also communicates with the server unit 500 (and the data store 505 associated therewith) through a data communication link 522 so that the server unit 500 can generate prompts to the service provider interface 521 and receive and store responses from the service provider interface 521. The service provider interface 521 can also initiate communication with the server unit 500 using the data communication link 522 to access services provided by the server unit 500, for example, to retrieve service session information provided by a user prior to a service session, retrieve service provider instructions from a previous service session interaction, access the permanent data record associated with a user or access informational content accessible through the server unit 500. The multi-window user interface 511 can provide additional windows so that several of these interactions can occur simultaneously through respective windows.

The service provider interface 521 and the user interface 511 also allow for prompts or displays to be provided directly to each other. Therefore, the service provider interface 521 allows, for example, a service provider to display, in a user interface 511 window, a chart or diagram while the service session interaction using the audio/video channel 530 is taking place.

In one important aspect of the digital dialog feature of the present invention, the data associated with a service session and a user is stored in a permanent data record in the data store 505. Typically, such data associated with multiple service sessions, respectively, can be stored in the data store so that an accurate service session interaction history can be kept.

Furthermore, the prior stored data of a user can be used to generate appropriate prompts to both the user and the service provider so that the effectiveness of the service session is greatly increased and number of errors by a service provider is minimized. In addition, the stored data can also be used to automatically generate service related activity, for example, schedule follow up service sessions, generate referrals for other services, generate prescriptions and refills, provide reminders, generate bills, determine service effectiveness, provide outcomes research data and the like as discussed earlier herein.

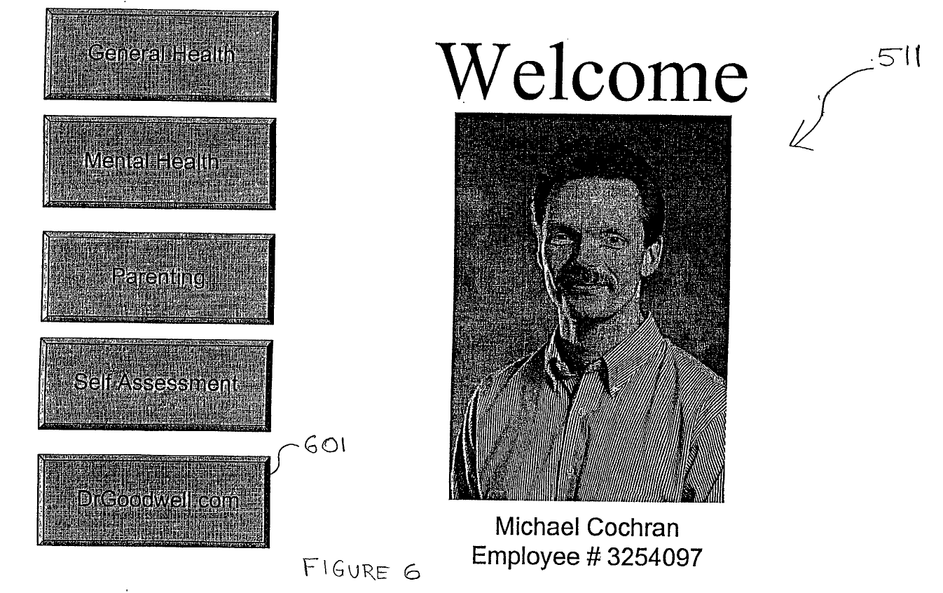

FIGS. 6-12 illustrate an exemplary service session interaction that uses some of the digital dialog features according to the present invention. The exemplary service session interaction is between a patient (for example, a corporate employee corresponding to the user) and a medical doctor (corresponding to the service provider). FIG. 6 illustrates a user interface 511 display provided, for example, on a user desktop (corresponding to the user computing unit 510) in a corporate network. The user interface 511 includes various buttons useful to the corporate employee patient including a button 601 for interacting with the server unit 500. The patient connects to the server unit 500 for a service session interaction with a particular doctor to discuss his cough problem. The service session could be scheduled in advance or could be sought by the patient on an adhoc basis.

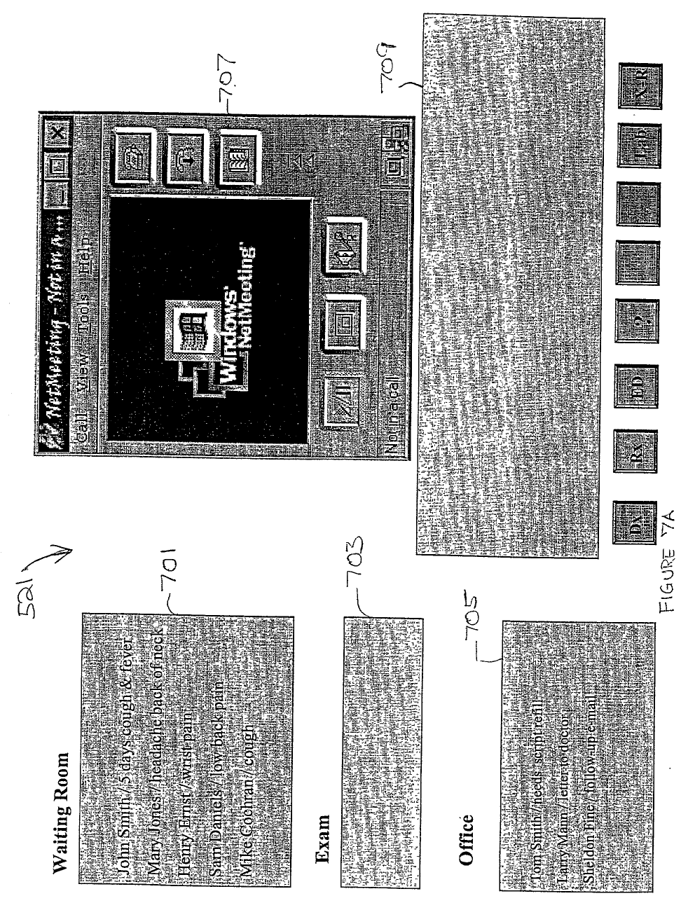

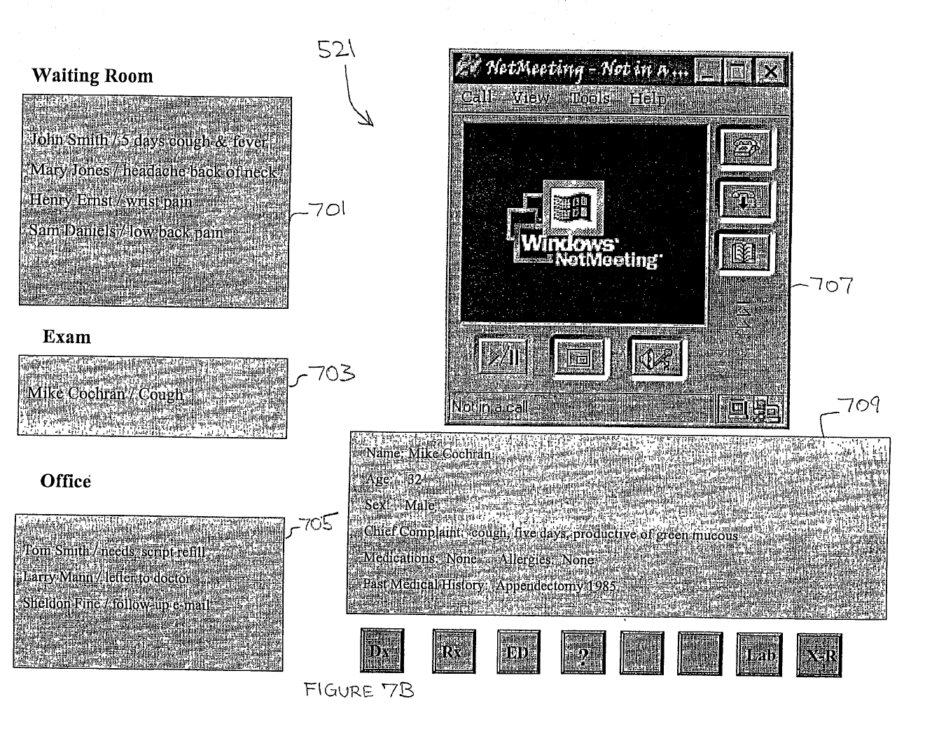

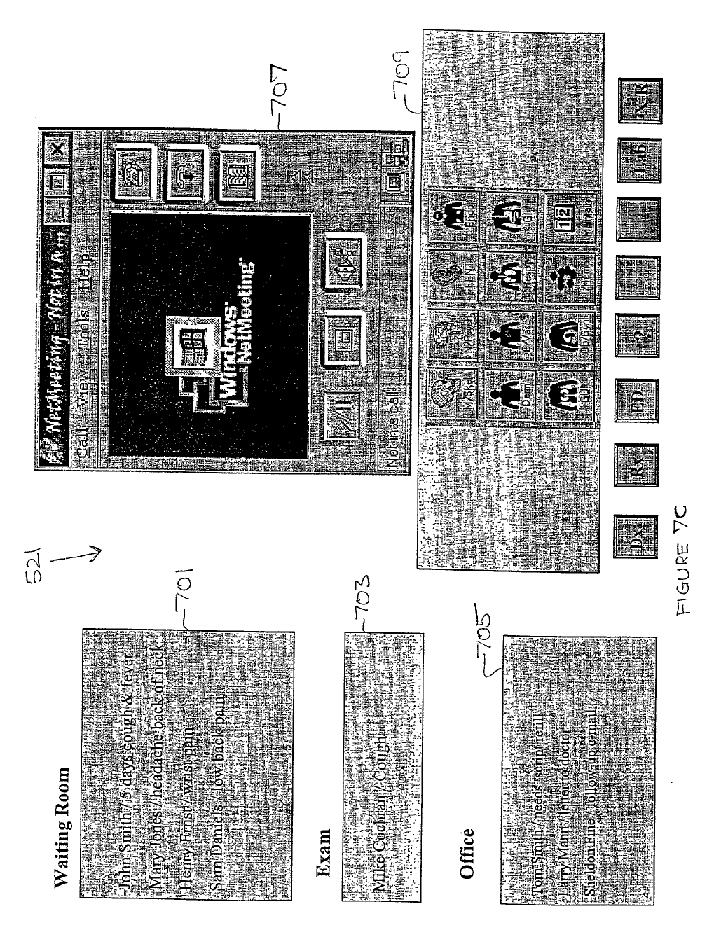

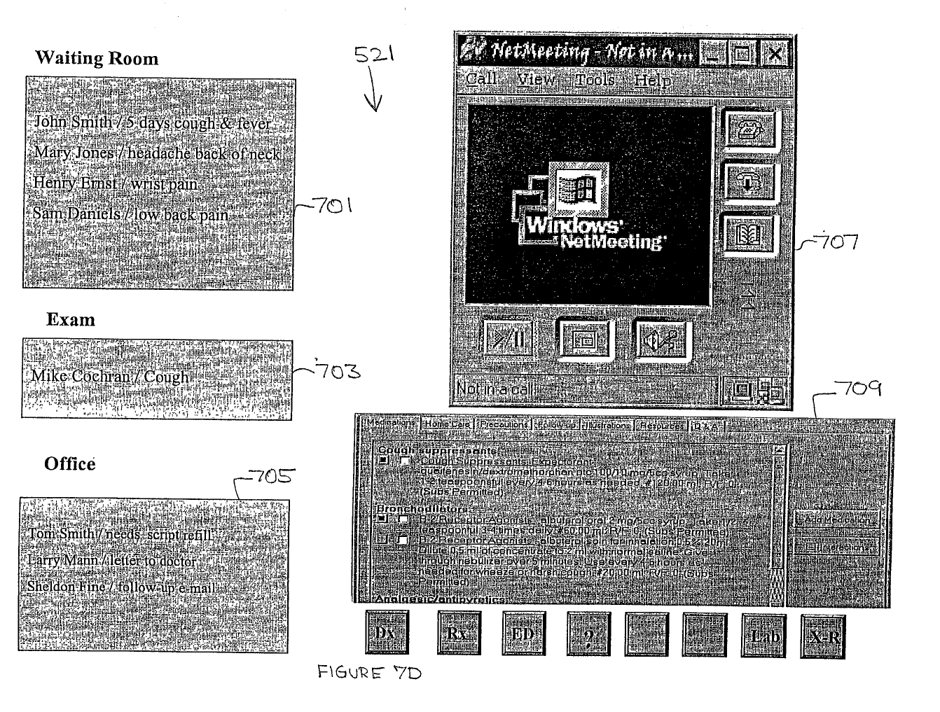

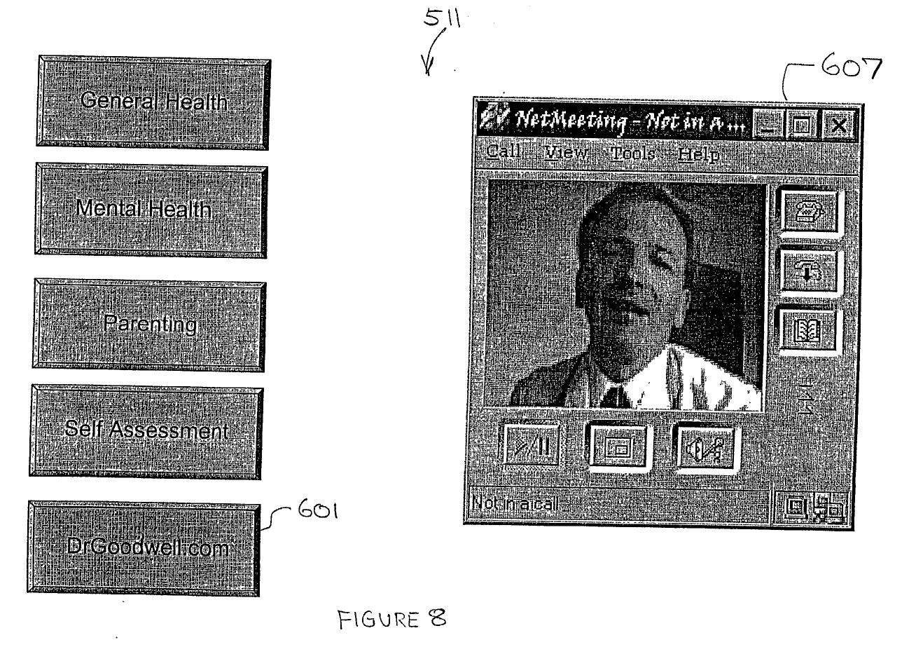

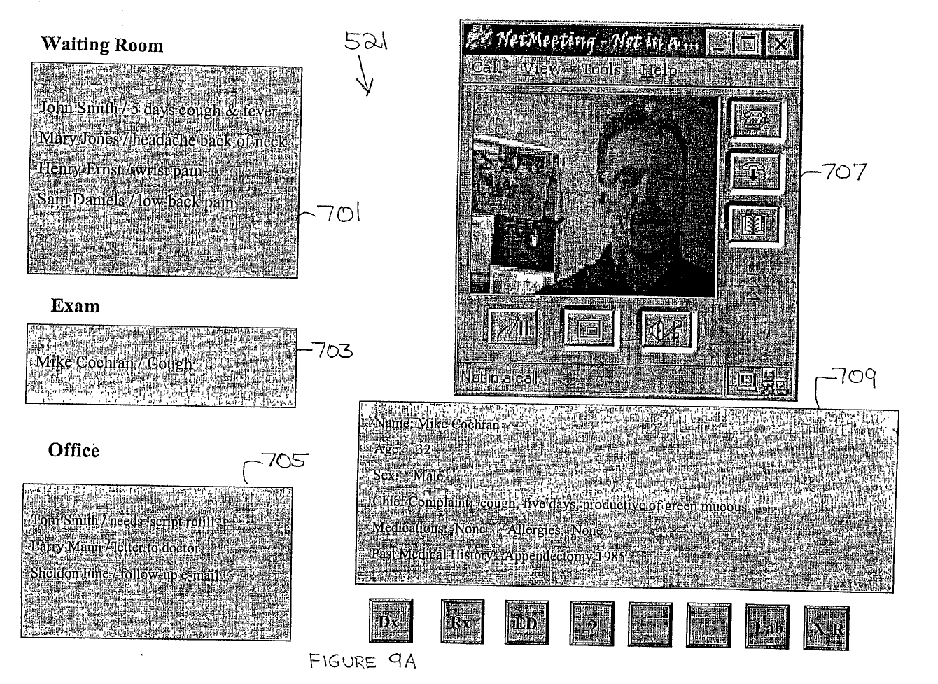

FIGS. 7A-7D illustrate various stages visible in the doctor (or service provider) interface 521 (in a service provider computing unit 520) after the patient has connected to the server unit 500 for his service session interaction. As shown in FIG. 7A, a waiting room window 701 is displayed (for example, in a separate window) in which all patients waiting for service are listed. The server unit 500 may prioritize the patients in the waiting room 701 using prioritization algorithms well known to those skilled in the art, such as, First In First Out (FIFO), or based on preferences for particular user types or diseases or symptoms. An exam window 703 displays the patient that is currently scheduled for a service session. An office window 705 indicates office related tasks that may be pending. A prompt window 709 provides the doctor with access to data and information stored in the server unit 500 or accessible from other sources. A service session window 707 provides access to the audio/visual communication channel 530 to establish and conduct the audio/video service session with the patient. Such an access to the audio/video communication channel can be provided by using a commercially available product, such as Microsoft's Windows NetMeeting, that allows videoconferencing over the Internet or other computer network with a computing device and a video camera that can be connected to the computing device.

FIG. 7B shows that a patient (Mike Cochran/Cough) has been scheduled for a service session in the exam window 703 and has been removed from the waiting room 701. The prompt window 709 now displays information relevant to the service session, for example, based on service session related information provided earlier by the patient or from prior data related to the patient stored in the data store 505. In FIGS. 7C and 7D, the doctor uses the prompt window 709 to retrieve relevant information for treatment of the patient in the current service session.

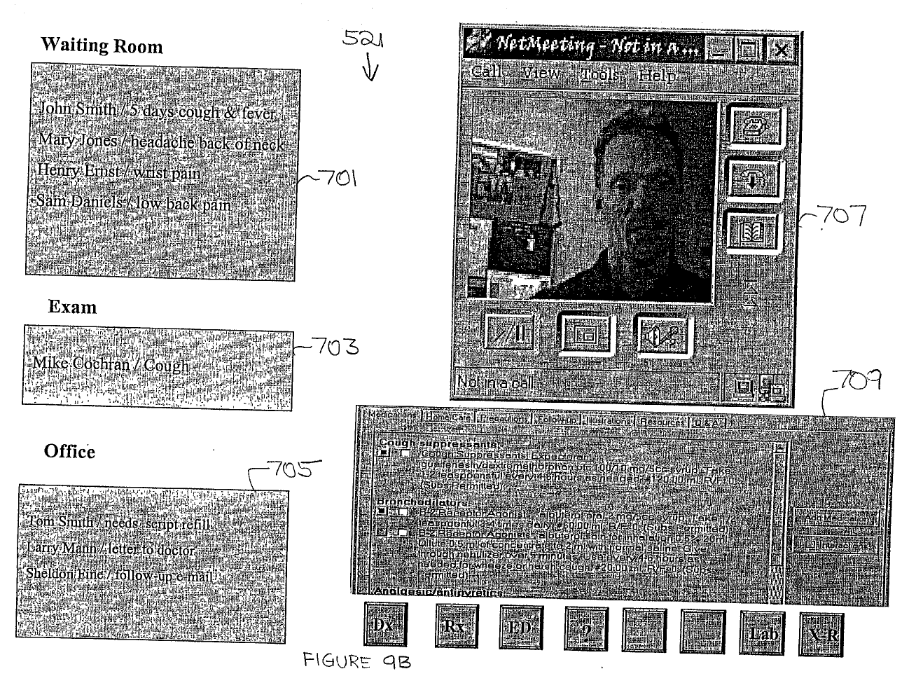

FIG. 8 illustrates the patient user interface 511 display after the doctor has initiated a videoconference (service session) with the patient. A service session window 607 communicates with the audio/video communication channel 530 to receive audio/video data from the service provider computing unit 520. As discussed earlier, a commercial product, such as Microsoft Windows NetMeeting, may be used to provide the service session window 607 that videoconferences with the service provider (doctor) computing unit 520.

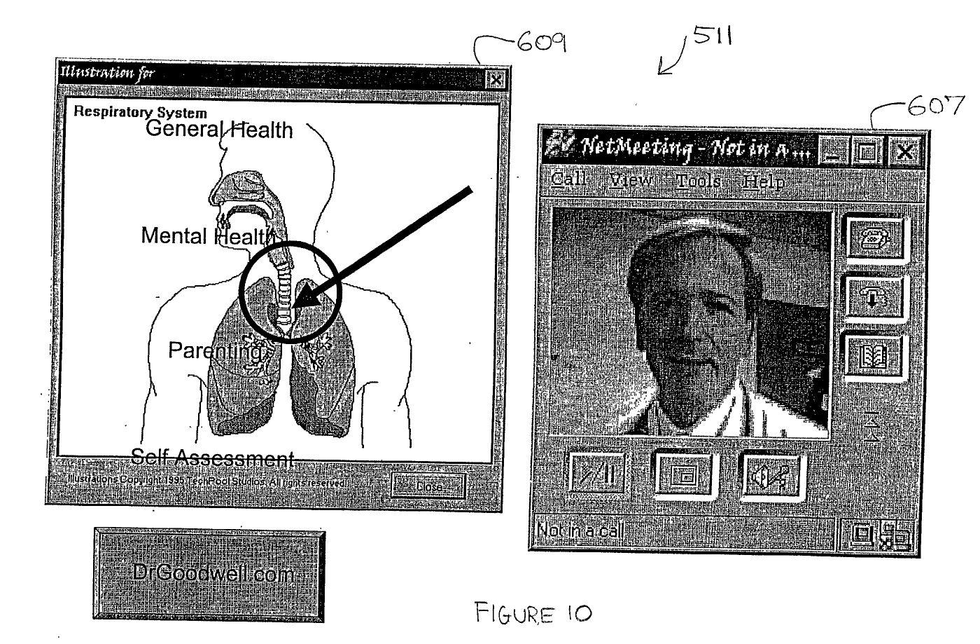

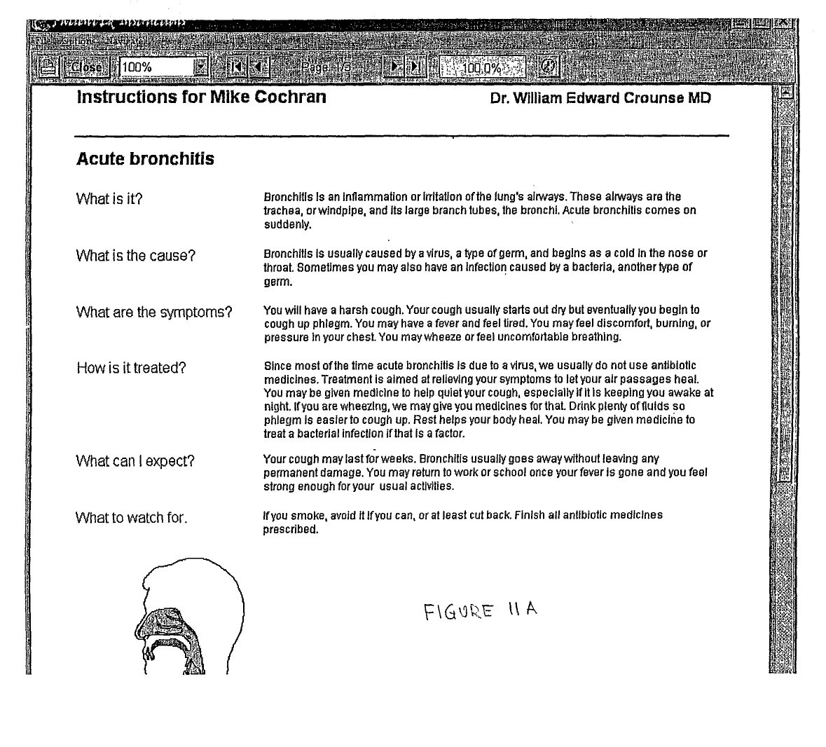

FIGS. 9A and 9B illustrate the service provider (doctor) interface display after the service session with the patient is in progress using window 707. In FIG. 9A, the prompt window 709 displays patient information, while in FIG. 9B, the prompt window 709 displays treatment information while the audio/video service session is taking place.

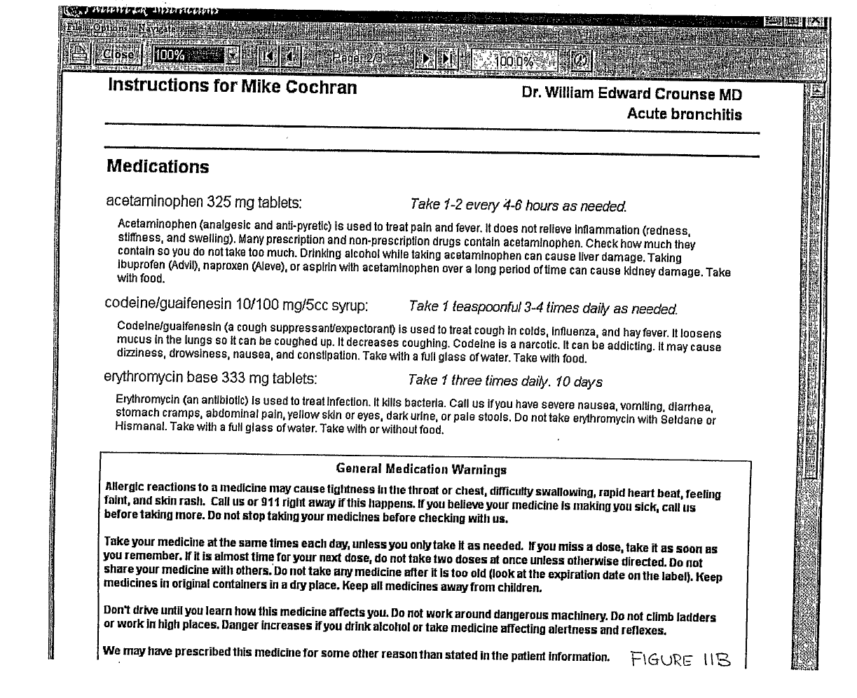

FIG. 10 illustrates the user (patient) interface display 511 while the service session is being conducted. A prompt window 609 displays information to the patient that is provided by the doctor. The prompt window 609 may also be used to display data to the patient from the server unit 500, as appropriate.

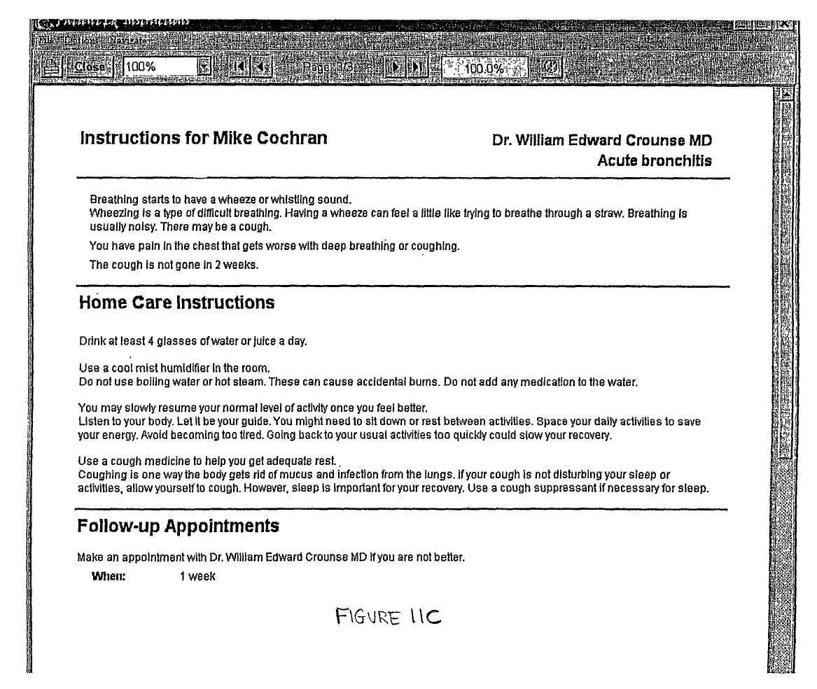

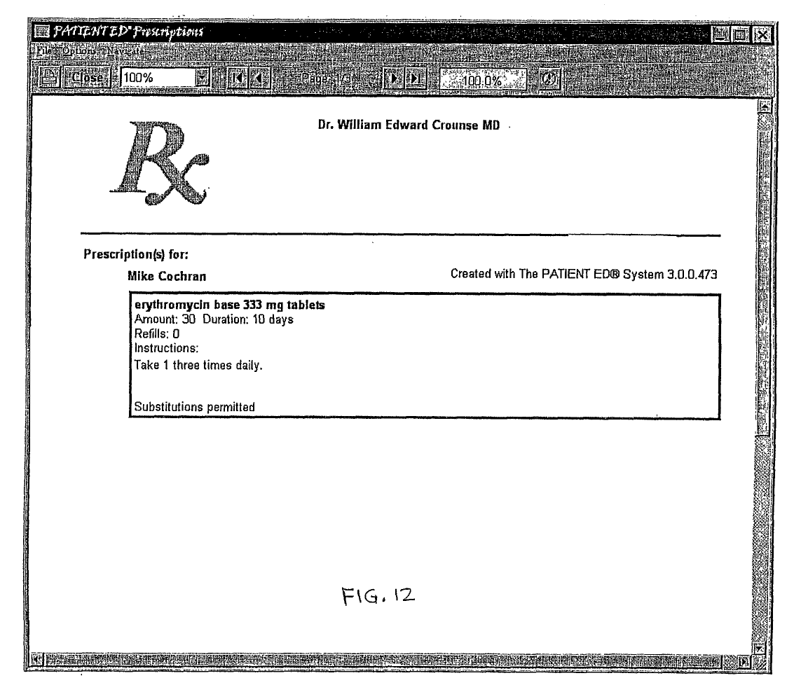

FIGS. 11A-11C show treatment related instructions for the patient based on the service session and FIG. 12 shows a prescription for treatment of the patient based on the service session interaction and the data associated with the service session in the digital dialog of the present invention. The instructions and prescriptions are visible to both the patient and the doctor and are stored in the data store 505 of the server unit 500.

Furthermore, the present invention contemplates automated activity based on the service session related and other data stored in the data store 505. For example, the prescriptions and refills can be automatically transmitted to pharmacies and reminders (for example, by e-mail or voice mail) can automatically be sent to patients. Follow up activities can be automatically set up and tracked. Finally, data associated with the digital data can be used for outcome research or for tracking service related parameters.

Other embodiments of the invention will be apparent to those skilled in the art from a consideration of the specification and the practice of the invention disclosed herein. It is intended that the specification be considered as exemplary only, with the true scope and spirit of the invention being indicated by the following claims.

What is claimed is:

1. A computer implemented method of providing personal services over a computer network, the method comprising the steps of:
receiving a service request from a user;
determining a user type;
providing a menu of service request options corresponding to the determined user type;
receiving a selected service request option from the user;
determining a service response based on information related to the user;
providing services in accordance with the selected service request option and the determined service response; and
recording interactions while providing the selected service request option.

2. The computer implemented method according to claim 1, wherein the personal services comprises healthcare related services.

3. The computer implemented method according to claim 2, wherein the user type comprises one of a member/employee, a service provider, an administrator, a research service, and a service partner.

4. The computer implemented method according to claim 3, wherein if the user type is member/employee, the menu of service option requests comprises view services available, news, communication, update/create user profile, schedule appointment, immediate consultation, perform transaction, check status, provide feedback/comments.

5. The computer implemented method according to claim 3, wherein if the user type is service provider the menu of service request options comprises news, knowledge base, administration, feedback query, and communication.

6. The computer implemented method according to claim 3, wherein if the user type is administrator, the menu of service request options comprise news, initiate query, communications, and help request.

7. The computer implemented method according to claim 3, wherein if the user type is research services the service request options comprise news, accessible databases, and queries.

8. The computer implemented method according to claim 3, wherein of the user type is service partner the service request options comprise news, performance query, and data/information exchange.

9. The computer implemented method according to claim 3, wherein the step of recording interactions includes storing information regarding type of service provided, user requesting service, service provider information and recommendations, frequency of service provided by user and/or service provider, outcome information, feedback from user, and performance metrics.

10. The computer implemented method according to claim 9, further comprising the steps of:
calculating outcome data; and
providing non-confidential outcome data to a research service.

11. The computer implemented method according to claim 9, further comprising the steps of:
calculating service usage by user, service type, and outcomes; and providing calculated service usage to an administrator.

12. The computer implemented method according to claim 11, further comprising the step of:
determining, by the administrator, a list of services provided based on the calculated service usage information.

13. The computer implemented method according to claim 9, further comprising the steps of:
calculating performance metrics by respective service providers; and
provide respective performance metrics to the respective service providers.

14. The computer implemented method according to claim 9, further comprising the steps of:
calculating performance metrics by service providers; providing calculated performance metrics by service providers to an administrator.

15. The computer implemented method according to claim 14, further comprising the step of:
selecting or rewarding/penalizing one or more service providers, by an administrator, based on performance metrics of the respective service providers.

16. The computer implemented method according to claim 2, wherein the service response is determined based on information related to the medical history of the user.

17. The computer implemented method according to claim 2, wherein the service response is determined based on information related to a work schedule of the user.

18. The computer implemented method according to claim 2, wherein the service response is determined based on information related to an estimated condition of the user.

19. A computer readable data storage medium having program code recorded thereon for providing personal services over a computer network, the program code comprising:
a first program code that receives a service request from a user and determines user type;
a second program that provides a menu of service request options based on determined user type;
a third program code that receives a selected service request option from the user;
a fourth program code that determines a service response based on information related to the user;
a fifth program code that provides services in accordance with the selected service request option and the determined service response; and
a sixth program code that records interactions while providing the selected service request options.

20. A system for providing personal services over a computer network, the system comprising:
a user interface unit for receiving a service request from a user and determining a user type;
a server unit that provides a menu of service request options based on the user type and receives a user selected service request option through the user interface unit, the server unit determining a service response based on information related to the user and providing services in accordance with the selected service request option and the determined service response; and
a data storage unit that records all interactions while providing the selected service request option.

21. The system according to claim 20, wherein the interactions recorded in the data storage unit includes storing information regarding type of service provided, user requesting service provider information and recommendations, frequency of service provided by user and/or service provider, outcome information, feedback from user, and performance metrics.

22. The system according to claim 21, wherein the server unit calculates outcome data and provides non-confidential outcome data to a research service.

23. The system according to claim 21, wherein the server unit calculates service usage by user, service type, and outcomes, and provides calculated service usage data to an administrator.

24. The system according to claim 21, wherein the server unit calculates performance metrics by service providers, and provides calculated performance metrics to an administrator.

25. The system according to claim 20, wherein the server unit determines the service response based on a prior history of the user.

26. The system according to claim 20, wherein the server unit determines the service response based on information related to a work schedule of the user.

27. The system according to claim 20, wherein the server unit determines the service response based on information related to an estimated condition of the user.

28. A computer network implemented method of providing personalized services using a digital dialog between a service provider and a user of the personalized services, the method comprising:
establishing an audio/video communication channel for a service session between the user and the service provider;
receiving and storing inputs from the service provider in a data store while the audio/video communication channel between the user and the service provider is established;
receiving and storing inputs from the user in the data store while the audio/video communication channel between the user and the service provider is established; and
providing, the service provider and the user, interactive access to the data store while the audio/video communication channel is established between service provider and the user.

29. The method according to claim 28, further comprising:
prior to establishing the service session using the audio/video communication channel, scheduling the service session based on input from the user; and
receiving service session related information from the user; and storing received service session related information in the data store.

30. The method according to claim 28, wherein the service provider can access user inputs stored on the data store.

31. The method according to claim 28, wherein the user can access selected service provider inputs stored on the data store.

32. The method according to claim 29, further comprising:
associating, with the service session or the service session related information, interactive prompts to the service provider;
receiving and storing service provider responses to the prompts provided to the service provider; and
providing additional prompts to the service provider based on the received responses from the service provider.

33. The method according to claim 32, further comprising:
providing interactive prompts to the user;
receiving and storing user responses to the prompts provided to the user; and
providing additional prompts to the service provider based on the received responses from the service provider.

34. The method according to claim 32, further comprising:
providing, from the service provider, interactive prompts to the user;
receiving, from the user, responses to the interactive prompts provided by the service provider; and
providing to the service provider the received responses from the user.

35. The method according to claim 34, further comprising:
storing the prompts and received responses as a permanent data record for the service session.

36. The method according to claim 35, wherein the prompts and received responses are stored and classified in the permanent data record based on keywords associated with the prompts and received responses.

37. The method according to claim 36, wherein the prompts comprise labeled or unlabeled data entry fields, diagrams, prior session data, or service session related information provided by the user prior to the service session.

38. The method according to claim 28, wherein the audio/video communication channel includes videoconferencing.

39. The method according to claim 28, wherein the audio/video communication channel comprises a communication channel over a public or private communication network.

40. The method according to claim 39, wherein the public communication channel comprises the Internet.

41. The method according to claim 39, wherein the audio/video communication channel includes a browser access to the public or private communication channel.

42. The method according to claim 39, further comprising:
providing the service provider with a multi-window interface to the communication channel, wherein one or more windows provide access to audio/video data transmitted across the communication channel,
wherein one or more windows synchronously provide access to the data store storing inputs from the service provider and the user and any earlier service session related information provided by the user; and
one or more windows synchronously provide access to one or more information sources useful to the service provider.

43. The method according to claim 42, further comprising:
providing the user with a multi-window interface, wherein one or more windows provide access to the audio/video communication channel, and
wherein one or more windows synchronously provide access to additional information useful to the user.

44. The method according to claim 28, wherein the service provider is a doctor or a medical professional and the user is a patient.

45. The method according to claim 28, wherein the service provider is a travel agent and the user is a customer of the travel agent.

46. The method according to claim 44, wherein the step of establishing an audio/video communication channel further comprises:
placing a received user connection in a “waiting room” queue for a particular service provider; monitoring the queue by using a priority protocol to schedule the users in the queue, and communicating with the service provider and the user to initiate the service session in accordance with the schedule.

47. The method according to claim 46, further comprising: providing a user with an indication of their position in the queue.

48. The method according to claim 36, further comprising:
generating asynchronous message to the user or the service provider based on data stored in the permanent data record.

49. The method according to claim 48, wherein the asynchronous message comprises an e-mail or voice mail message, pager or PDA alert, or scheduling of a follow up or a different service session.

50. The method according to claim 42, wherein the one or more windows providing synchronous access to information sources provides interactive access to external information sources and links accessible therefrom.

51. The method according to claim 42, wherein the one or more windows providing access to the data store provide interactive access to the information stored in the data store and to links accessible therefrom.

52. A computer readable data storage medium having program code recorded thereon for providing personalized services using a digital dialog over a computer network between a service provider and a user of the personalized services, the program code comprising:
a first program code for establishing an audio/video communication channel for a service session between the user and the service provider;
a second program code that receives and stores inputs from the service provider in a data store while the audio/video communication channel between the user and the service provider is established;
a third program code for receiving and storing inputs from the user in the data store while the audio/video communication channel between the user and the service provider is established; and
a fourth program code that provides the service provider and the user interactive access to the data store while the audio/video communication channel is established between the service provider and the user.

53. A system for providing personalized services using a digital dialog over a computer network between a service provider and a user of the personalized services, the system comprising:
a service provider interface that communicates with a user interface using an audio/video communication channel in a service session; and
a server unit that communicates with both the service provider interface and the user interface while the service provider interface communicates with the user interface using the audio/video communication channel in the service session;
wherein the server unit comprises a data store that is interactively accessible by the service provider interface and the user interface during the service session.

54. The system according to claim 53, wherein, prior to establishing the service session, the server unit schedules the service session based on input received from the user interface, receives service session related information from the user interface and stores the received service session related information in the data store.

55. The system according to claim 53, wherein the user interface provides access to selected service provider inputs stored in the data store, and the service provider interface provides access to user inputs stored in the data store.

56. The system according to claim 54, wherein the server unit provides prompts to the service provider interface based on the service session or the service session related information, and receives and stores service provider responses to the prompts provided to the service provider interface.

57. The system according to claim 56, wherein the server unit provides interactive prompts to the user interface, and receives and stores user responses to the prompts provided to the user interface.

58. The system according to claim 57, wherein the service provider interface generates service provider prompts to the user interface, and displays user responses to the service provider prompts, and
wherein the server unit stores all prompts and responses, in the data store, as a permanent data record associated with the service session.

59. The system according to claim 58, wherein the server unit classifies the stored prompts and responses based on keywords associated with the prompts and responses.

60. The system according to claim 59, wherein the prompts comprise labeled or unlabeled data entry fields, diagrams, prior session data, or service session related information provided by the user prior to the service session.

61. The system according to claim 53, wherein the audio/video communication channel comprises videoconferencing.

62. The system according to claim 53, wherein the audio/video communication channel comprises a communication channel over a public or private communication network.

63. The system according to claim 62, wherein the public communication network includes the Internet.

64. The system according to claim 62, wherein the service provider interface comprises a multi-window interface with one or more windows providing access to the audio/video communication channel, one or more windows synchronously provide access to the server unit and the data store, and one or more windows provide access to information sources useful to the service provider.

65. The system according to claim 64, wherein the user interface comprises a multi-window interface with one or more windows providing access to the audio/video communication channel, and one or more windows synchronously provide access to the server unit and the data store, and one or more windows provide access to information sources useful to the user.

66. The system according to claim 65, wherein the server unit includes a waiting room queue for a particular service provider,
wherein the server unit receives and places user connection requests for that particular service provider in the queue, monitors the queue in accordance with a priority protocol, and communicates with the user interface and the service provider interface to schedule the users in the queue in accordance with the priority protocol.
